(19) United States
(12) Patent Application Publication
(10) Pub. No.: US 2010/0266746 A1
(43) Pub. Date: Oct. 21, 2010

(54) SPREAD FORMULATIONS INCLUDING STEARIDONIC ACID

(75) Inventor: Richard S. Wilkes, Chesterfield, MO (US)

Correspondence Address: Armstrong Teasdale LLP (Monsanto #1 -BVO);Christopher M. Goff, 7700 Forsyth Boulevard, Suite 1800, St. Louis, MO, 63105, US

(73) Assignee: Monsanto Technology LLC, St. Louis, MO (US)

(21) Appl. No.: 12/425,118

(22) Filed: Apr. 16, 2009

(51) Int. Cl. A23D 7/005

(52) U.S. Cl. 426/603; 426/602; 426/417

(57) ABSTRACT

The present disclosure provides for improved spread formulations and methods of producing such formulations by incorporating healthy lipids containing stearidonic acid into the formulations. In one embodiment of the disclosure, a spread formulation including a SDA-enriched oil is disclosed. In another embodiment of the disclosure, a margarine spread formulation including a SDA-enriched soybean oil is disclosed.

### FIELD OF THE DISCLOSURE

The disclosure relates to the enhancement of desirable characteristics in spread formulations such as margarine spreads through the incorporation of beneficial fatty acids. More specifically, it relates to spread formulations comprising polyunsaturated fatty acids including stearidonic acid and to methods of producing the formulations thereof. These modified spread formulations show an improvement in nutritional quality while maintaining shelf-life compared to conventional margarine spread formulations.

### BACKGROUND OF THE DISCLOSURE

The present disclosure is directed to spread formulations such as margarine spreads including stearidonic acid (“SDA”) or SDA-enriched oil. Specifically, the present disclosure provides margarine spread formulations that have improved nutritional quality and methods of producing the spread formulations.

Many studies have made a physiological link between dietary fats and pathologies such as obesity and atherosclerosis. In some instances, consumption of fats has been discouraged by the medical establishment. More recently, the qualitative differences between dietary fats and their health benefits have been recognized.

Recent studies have determined that despite their relatively simple biological structures, there are some types of fats that appear to improve body function in some ways. Some fats may, in fact, be essential to certain physiological processes. The wider class of fat molecules includes fatty acids, isoprenols, steroids, other lipids and oil-soluble vitamins. Among these are the fatty acids. The fatty acids are carboxylic acids, which have from 2 to 26 carbon atoms in their “backbone,” with none or few desaturated sites in their carbohydrate structure. They generally have dissociation constants (pKa) of about 4.5 indicating that in normal body conditions (physiological pH of 7.4) the vast majority will be in a dissociated form.

With continued experimentation, workers in the field have begun to understand the nutritional need for fats and in particular fatty acids in the diet. For this reason, many in the food industry have begun to focus on fatty acids and lipid technology as a new focus for food production, with its consequent benefits for the consumers consuming the modified products. This focus has been particularly intense for the production and incorporation of omega-3 fatty acids into the diet. Omega-3 fatty acids are long-chain polyunsaturated fatty acids (18-22 carbon atoms in chain length) (LC-PUFAs) with the first of the double bonds (“unsaturations”) beginning with the third carbon atom from the methyl end of the molecule. They are called “polyunsaturated” because their molecules have two or more double bonds “unsaturations” in their carbohydrate chain. They are termed “long-chain” fatty acids since their carbon backbone has at least 18 carbon atoms. In addition to stearidonic acid “SDA” the omega-3 family of fatty acids includes alpha-linolenic acid (“ALA”), eicosatetraenoic acid (ETA), eicosapentaenoic acid (“EPA”), docosapentaenoic acid (DPA), and docosahexaenoic acid (“DHA”). ALA can be considered a “base” omega-3 fatty acid, from which EPA and DHA are made in the body through a series of enzymatic reactions, including the production of SDA. Most nutritionists point to DHA and EPA as the most physiologically important of the omega-3 fatty acids with the most beneficial effects. However, SDA has also been shown to have significant health benefits. See for example, U.S. Pat. No. 7,163,960 herein incorporated by reference. Furthermore, it has now been shown that SDA readily enriches the EPA level in red blood cells.

The synthesis process from ALA is called “elongation” (i.e., the molecule becomes longer by incorporating new carbon atoms) and “desaturation” (i.e., new double bonds are created), respectively. In nature, ALA is primarily found in certain plant leaves and seeds (e.g., flax) while EPA and DHA mostly occur in the tissues of cold-water predatory fish (e.g., tuna, trout, sardines and salmon), and in some marine algae or microbes that they feed upon.

In addition to difficulties with simply securing an appropriate supply of LC-PUFAs for societal consumption, often the cost to process LC-PUFAs into food products is restrictive. These omega-3 fatty acids, and some of the other LC-PUFAs can be quickly oxidized leading to undesirable odors and flavors. To reduce the rate of oxidation food processors must therefore either distribute the oil in a frozen condition or encapsulate the desirable fatty acids, each greatly increasing the cost of processing and consequent cost to the consumer. Despite this increased expense, food companies are interested in supplying omega-3 fatty acids and generally healthier food oils because they believe that health conscious consumers may be willing to pay a small premium for an improved diet if a reliable supply can be developed.

Along with the movement of food companies to develop and deliver essential fats and oils as an important component in a healthy human diet, governments have begun developing regulations pushing for the adoption of PUFAs in the diet. There has been difficulty in supplying these needs, however, as there has been an inability to develop a large enough supply of omega-3 containing oil to meet growing marketplace demand.

Furthermore, as already mentioned, the omega-3 fatty acids commercially deemed to be of highest value, EPA and DHA, which are provided in marine sources, also chemically oxidize very quickly over time limiting commercial availability. Importantly, during the rapid process of EPA and DHA degradation these long chain fatty acids develop rancid and profoundly unsatisfactory sensory properties (e.g., fishy odor and taste) that make their inclusion in many foodstuffs or products difficult or impossible from a commercial acceptance perspective. As such, previous attempts to incorporate omega-3 fatty acids into spread formulations have not met with much success as they have included the addition of highly unstable EPA or DHA.

Furthermore, attempts at incorporating traditional omega-3 fatty acids such as alpha-linolenic acid (ALA) are not practical as these fatty acids are not converted to the beneficial forms efficiently enough. Nutritional studies have shown that, compared to ALA, SDA is 3 to 4 times more efficiently converted in vivo to EPA in humans (Ursin, 2003).

These limitations on supply, stability and sourcing greatly increase cost and correspondingly limit the availability of dietary omega-3 fatty acids. Accordingly, a need exists to enhance the nutritional quality and shelf-life of foodstuffs, and in particular, of spread formulations. The SDA-containing compositions of the current disclosure not only provide needed dietary fat for specific consumers, but also provide other dietary improvements for the commercial production of spread formulation.

In addition, a need exists to provide a consumer-acceptable means of delivering EPA and DHA or critical precursors in spread formulations in a commercially acceptable way. The current disclosure provides an alternative to fish or microbe-supplied omega-3 fatty acids in the form of spread formulations comprising beneficial omega-3 fatty acids and does so utilizing a comparatively chemically stable omega-3 fatty acid, SDA, as a source that offers improved cost-effective production and abundant supply as derived from transgenic plants.

### SUMMARY OF THE DISCLOSURE

The present disclosure includes the incorporation of oil from transgenic plants engineered to contain significant quantities of stearidonic acid (18:4ω3) (SDA) for use in spread formulations to improve the fatty acid profile in the resulting formulations and/or the health of an end consumer. According to embodiments of the current disclosure, SDA-containing oils provide enhanced nutritional quality relative to traditional omega-3 alternatives such as flaxseed and lack negative taste and low stability characteristics associated with fish oil. Therefore, a preferred embodiment of this disclosure includes a spread formulation with an increased level of beneficial polyunsaturated fatty acids such as SDA.

In another embodiment of the disclosure, an oil-in-water emulsion spread formulation is provided. The spread formulation includes an oil phase and an aqueous phase. The oil phase includes a SDA-enriched oil.

In another embodiment of the disclosure, a margarine spread formulation including SDA-enriched soybean oil is provided.

Furthermore, methods of making spread formulations as described above are disclosed. These methods may include providing an oil phase including a stearidonic acid-enriched oil; providing an aqueous phase; and contacting the oil phase and the aqueous phase to make an oil-in-water emulsion spread formulation.

Exemplary stearidonic acid sources for obtaining the stearidonic acid-enriched oil may include transgenic soybeans, transgenic soybean oil, transgenic canola, transgenic canola oil, echium, and echium oil. Additional stearidonic acid sources may include seeds such as soybeans, safflower, canola, echium and corn.

In at least one embodiment, the SDA-enriched oil includes from about 10% (by weight) to about 60% (by weight) of SDA. In another embodiment, the SDA-enriched oil includes from about 10% (by weight) to about 30% (by weight) of SDA. In an even more particularly preferred embodiment, the SDA-enriched oil includes about 20% (by weight) SDA.

In at least one embodiment, the spread formulation including the SDA-enriched oil includes about 375 mg SDA-enriched oil in a 14-gram serving of the spread formulation. This amount ensures providing the end consumer with the minimum amount of SDA per day needed to enrich EPA in tissues based on James, et al. (2003). In another embodiment, the spread formulation includes about 1.875 g SDA-enriched oil in a 14-gram serving. The amount of SDA in the enriched oil may vary due to Germplasm, environmental effects, and the like. Typically, however, the SDA-enriched oil provides from about 10% (by weight) to about 60% (by weight) SDA, more preferably from about 10% (by weight) to about 30% (by weight), and even more preferably, about 20% (by weight) SDA.

Other features and advantages of this disclosure will become apparent in the following detailed description of preferred embodiments of this disclosure, taken with reference to the accompanying figures.

### BRIEF DESCRIPTION OF THE FIGURE

FIG. 1 depicts one embodiment of the present disclosure for producing the spread formulation including an SDA-enriched oil.

### DEFINITIONS

The following definitions are provided to aid those skilled in the art to more readily understand and appreciate the full scope of the present disclosure. Nevertheless, as indicated in the definitions provided below, the definitions provided are not intended to be exclusive, unless so indicated. Rather, they are preferred definitions, provided to focus the skilled artisan on various illustrative embodiments of the disclosure.

As used herein the term “spread formulation” refers to an oil-in-water emulsion including about 80% (by weight) fat or less. Typically, the spread formulations of the present disclosure include from about 20% (by weight) to about 80% (by weight) fat, and more suitably, from about 25% (by weight) to about 75% (by weight) fat. In some particularly preferred embodiments, the spread formulations include about 60% (by weight) fat.

As used herein the term “margarine spread formulation” refers to an oil-in-water emulsion including about 80% (by weight) fat, and would include margarines as defined in USCFR21:166.40, margarine and spread formulations blended with butter and butter.

As used herein the term “SDA-enriched oil” refers to an oil including at least about 10% (by weight) SDA.

As used herein the term “interesterified oils” refers to an oil produced by mixing small amounts of fully hydrogenated oils with liquid polyunsaturated oils.

### DETAILED DESCRIPTION OF THE DISCLOSURE

### Production of SDA

The present disclosure relates to a system for an improved method for the plant based production of stearidonic acid and its incorporation into the diets of humans in an effort to improve human health. This production is made possible through the utilization of transgenic plants engineered to produce SDA in sufficiently high yield so as to allow commercial incorporation into food products. For the purposes of the current disclosure the acid and salt forms of fatty acids, for instance, butyric acid and butyrate, arachidonic acid and arachidonate, will be considered interchangeable chemical forms.

All higher plants have the ability to synthesize the main 18 carbon PUFAs, LA and ALA, and in some cases SDA (C18:4n3, SDA), but few are able to further elongate and desaturate these to produce arachidonic acid (AA), EPA or DHA. Synthesis of EPA and/or DHA in higher plants therefore requires the introduction of several genes encoding all of the biosynthetic enzymes required to convert LA into AA, or ALA into EPA and DHA. Taking into account the importance of PUFAs in human health, the successful production of PUFAs (especially the n-3 class) in transgenic oilseeds, according to the current disclosure can then provide a sustainable source of these essential fatty acids for dietary use. The “conventional” aerobic pathway which operates in most PUFA-synthesizing eukaryotic organisms, starts with Δ6 desaturation of both LA and ALA to yield γ-linolenic (GLA, 18:3n6) and SDA.

Turning to Table 1, it is important to provide a basis of what constitutes “normal” ranges of oil composition vis-à-vis the oil compositions of the current disclosure. A significant source of data used to establish basic composition criteria for edible oils and fats of major importance has been the Ministry of Agriculture, Fisheries and Food (MAFF) and the Federation of Oils, Seeds and Fats Associations (FOSFA) at the Leatherhead Food International facility in the United Kingdom.

To establish meaningful standards data, it is preferred that sufficient samples be collected from representative geographical origins and that these oils are pure. In the MAFF/FOSFA work, over 600 authentic commercial samples of vegetable oilseeds of known origin and history, generally of ten different geographical origins, were studied for each of 11 vegetable oils. The extracted oils were analyzed to determine their overall fatty acid composition (“FAC”). The FAC at the 2-position of the triglyceride, sterol and tocopherol composition, triglyceride carbon number and iodine value, protein values in the oil, melting point and solid fat content as appropriate are determined.

Prior to 1981, FAC data were not included in published standards because data of sufficient quality was not available. In 1981, standards were adopted that included FAC ranges as mandatory compositional criteria. The MAFF/FOSFA work provided the basis for later revisions to these ranges.

In general, as more data became available, it was possible to propose fatty acid ranges much narrower and consequently more specific than those adopted in 1981. Table 1 gives examples of FAC of oils that were adopted by the Codex Alimentarius Commission (CAC) in 1981 and ranges for the same oils proposed at the Codex Committee on Fats and Oils (CCFO) meeting held in 1993.

TABLE 1
Standards For Fatty Acid Composition Of Oils (% Of Oil)

| | | | Groundnut | | Cottonseed | | Sunflower-seed | |
|---|---|---|---|---|---|---|---|---|
| Fatty | Soybean oil | | oil | | oil | | oil | |
| acid | 981 | 993 | 981 | 993 | 981 | 993 | 981 | 993 |
| 14:0 | 0.5 | 0.2 | 0.6 | 0.1 | .4-2 | .6-1 | 0.5 | 0.2 |
| 16:0 | −14 | −13.3 | −16 | .3-14 | 7-31 | 1.4-26.4 | −10 | .6-7.6 |
| 16:1 | 0.5 | 0.2 | 1 | 0.2 | .5-2 | −1.2 | 1 | 0.3 |
| 18:0 | .4-5.5 | .4-5.4 | .3-6.5 | .9-4.4 | −4 | .1-3.3 | −10 | .7-6.5 |
| 18:1 | 9-30 | 7.7-26.1 | 5-72 | 6.4-67.1 | 3-44 | 4.7-21.7 | 4-65 | 4-39.4 |
| 18:2 | 4-62 | 9.8-57.1 | 3-45 | 4-43 | 3-59 | 6.7-58.2 | 0-75 | 8.3-74 |
| 18:3 | −11 | .5-9.5 | 1 | 0.1 | .1-2.1 | −0.4 | −0.7 | −0.2 |
| 20:0 | 1 | .1-0.6 | −3 | .1-1.7 | −0.7 | .2-0.5 | −1.5 | .2-0.4 |
| 20:1 | 1 | 0.3 | .5-2.1 | .7-1.7 | −0.5 | −0.1 | −0.5 | −0.2 |
| 22:0 | 0.5 | .3-0.7 | −5 | .1-4.4 | −0.5 | −0.6 | −1 | .5-1.3 |
| 22:1 | | 0.3 | 2 | 0.3 | −0.5 | −0.3 | −0.5 | −0.2 |
| 22:2 | | | | | | | | −0.3 |
| 24:0 | | 0.4 | .5-3 | .1-2.2 | −0.5 | −0.1 | −0.5 | .2-0.3 |
| 24:1 | | | | 0.3 | | | 0.5 | |

Sources: Codex Alimentarius Commission, 1983 and 1993.

More recently, oils from transgenic plants have been created. Some embodiments of the present disclosure may incorporate products of transgenic plants such as transgenic soybean oil. Transgenic plants and methods for creating such transgenic plants can be found in the literature. See for example, WO2005/021761A1. As shown in Table 2, the composition of the transgenic soy oil is substantially different than that of the accepted standards for soy oil.

TABLE 2
A comparison of transgenic soy oil and traditional soy oil fatty
acid compositions (% of Oil)

| | Low | | |
|---|---|---|---|
| | SDA | Medium SDA | High SDA |
| | Soy Oil | Soy Oil | Soy Oil |
| C14:0 (Myristic) | 0.10 | 0.11 | 0.10 |
| C16:0 (Palmitic)) | 12.23 | 12.33 | 12.52 |
| C16:1 (Palmitoleic) | 0.10 | 0.10 | 0.15 |
| C18:0 (Stearic) | 3.95 | 3.99 | 4.10 |
| C18:1 (Oleic) | 16.21 | 15.50 | 15.17 |
| C18:2 (Linoleic) | 34.04 | 29.40 | 18.46 |
| C18:3 n6 (Gamma Linolenic) | 4.30 | 5.50 | 4.71 |
| C18:3 n3 (Alpha-Linolenic) | 11.64 | 11.14 | 12.78 |
| C18:4 n3 (Stearidonic) | 14.51 | 18.86 | 28.92 |
| C20:0 (Arachidic) | 0.34 | 0.35 | 0.38 |
| C20:1 (Eicosenoic) | 0.21 | 0.21 | 0.22 |
| C22:0 (Behenic) | 0.32 | 0.32 | 0.34 |
| C24:0 (Lignoceric) | 0.10 | 0.09 | 0.09 |
| Other fatty acids | 0.56 | 0.60 | 0.69 |

According to embodiments of the current disclosure, the preferred plant species that could be modified to reasonably supply demand are: soybeans, canola, and echium but many other plants could also be included as needed and as scientifically practicable. For the present disclosure, the preferred source of SDA is transgenic soybeans which have been engineered to produce high levels of SDA. The soybeans may be processed at an oil processing facility and oil may be extracted consistent with the methods described in US Patent Applications 2006/0111578A1, 2006/0110521A1, and 2006/0111254A1.

It should be recognized that once produced, the SDA of the disclosure can be used to improve the health characteristics of a great variety of spread formulations. This production offers a sustainable crop-based source of omega-3 fatty acids that enriches EPA in red blood cells and other tissues, and has improved flavor and stability as compared to many alternative omega-3 fatty acid sources available today.

### Oil Phase:

As noted above, the spread formulations of the present disclosure include an oil phase and an aqueous phase. In one embodiment, in addition to the SDA-enriched oil, the oil phase further include oils such as hydrogenated oils, partially hydrogenated oils, and interesterified oils. Exemplary of these additional oils include partially hydrogenated oils having a solids fat index of from about 19% to 25.5% at 50° F. (10° C.), from about 10.5% to about 15.5% at 70° F. (21° C.), and from about 0.5% to about 4.0% at 92° F. (33° C.). Hydrogenated oils having this solids fat index will provide the spread formulation with the desired plastic texture. Furthermore, these oils will allow the spread formulations to adequately melt on food products and in the mouth, such as is desired of the spread formulations. Commercial hydrogenated and partially hydrogenated oils typically used in spread formulations are available from ADM (Decatur, Ill.). Specifically, one particularly preferred partially hydrogenated oil is Product No. 86-334-0, available from ADM (Decatur, Ill.). Other commercially available hydrogenated and partially hydrogenated oils can be obtained, for example, from Cargill (Minneapolis, Minn.), Bunge (St. Louis, Mo.), CHS (Inver Grove Heights, Minn.), AGP (Omaha, Nebr.), and Perdue (Salisbury, Md.). Interesterified oils are commercially available from ADM (Decatur, Ill.),

Typically, when used, the oil phase includes these additional oils in amounts of from about 20% (by weight) to about 80% (by weight). In one particularly preferred embodiment, the oil phase includes these additional oils in an amount of about 58% (by weight).

In addition to the oils mentioned above, in some embodiments, the oil phase further includes a liquid oil such as soybean oil, canola oil, rapeseed oil, palm, oil, and the like, and combinations thereof. Typically, these oils are refined, bleached and deodorized. These liquid oils provide improved flavor to the spread formulation. Liquid oils, such as soybean oil, further provide for improved texture and spreadability to the spread formulations. Furthermore, some liquid oils, such as palm oil provide a non-trans fat option to the spread formulations, thereby providing health benefits to the consumer along with improved flavor.

Typically, when used, the oil phase includes these additional liquid oils in amounts of from about 20% (by weight) to about 80% (by weight). In one particular embodiment, the oil phase includes the liquid oils in an amount of about 20% (by weight).

Other particularly preferred liquid oils that may be used in the oil phase of the spread formulation to stabilize the spread formulation include high stability oils. These oils can replace the conventional liquid oils described above to further slow down oxidation and off flavor development due to the polyunsaturated fat content in the omega-3 oils. Exemplary suitable high stability oils include low linolenic soybean oils, high oleic soybean oils, high oleic/low saturate soybean oils, high oleic canola oils, sunflower oils, and the like, and combinations thereof.

Typically, when used, the oil phase includes these high stability liquid oils in amounts of from about 0.1% (by weight) to about 35% (by weight). In one particular embodiment, the oil phase includes at least one high stability oil in an amount of about 19% (by weight).

Apart from the above fat blend of oils, the oil phase of the spread formulation may include minor fat-soluble ingredients such as emulsifiers, lecithin, flavoring agents, coloring agents, and combinations thereof.

Exemplary emulsifiers that can be included in the oil phase include monoglycerides and diglycerides, which can disperse the water particles in the oil-in-water emulsion spread formulation and prevent water spattering. Additionally, the monoglycerides and diglycerides can stabilize the emulsion spread formulation. Exemplary monoglycerides and diglycerides include those commercially available from Eastman Chemical Company (Kingsport, Tenn.) and Danisco (Copenhagen, Denmark). Particularly suitable monoglycerides are Dimodan Distilled monoglycerides, commercially available from Danisco (Copenhagen, Denmark).

Typically, when used, the oil phase includes monoglycerides and diglycerides in amounts of from about 0.1% (by weight) to about 0.6% (by weight). In one particular embodiment, the oil phase includes monoglycerides and diglycerides in an amount of about 0.2% (by weight).

Lecithin may also be included in the oil phase to provide improved stability of the emulsion spread formulation. Additionally, it has been found that the inclusion of lecithin may aid in release of the product in frying applications.

Typically, when used, the oil phase includes lecithin in amounts of from about 0.1% (by weight) to about 0.2% (by weight). In one particular embodiment, the oil phase includes lecithin in an amount of about 0.2% (by weight).

Coloring agents may include any coloring agents known in the food processing agent. The coloring agents provide aesthetic value to the spread formulation. For example, when the spread formulation is a margarine spread formulation, beta carotene can be added to the oil phase of the spread formulation to provide adequate orange-yellow coloring.

Additionally, beta carotene, as with many of the other coloring agents, serves multiple functions in the spread formulations. More particularly, beta carotene can provide activity as Vitamin A in addition to behaving as a coloring agent. Fortification of all margarine spread formulations is mandatory under FDA guidelines. This mandatory Vitamin A level is typically attained by the addition of beta-carotene into the margarine spread formulation, which can be added as a vitamin blend, such as with Vitamin D.

Typically, when used, the oil phase includes one or more coloring agents in amounts of from about 0.001% (by weight) to about 0.3% (by weight). In one embodiment, the oil phase includes a coloring agent in an amount of about 0.002% (by weight). When beta-carotene is the coloring agent, and is further added to meet Vitamin A requirements, the level of beta-carotene is determined by the other components in the formulation and the required amounts of Vitamin A in the final spread formulation.

In many spread formulations provided in the present disclosure, it is desirable to enhance the flavoring. Particularly, when the spread formulation is a margarine spread formulation, it is desirable to include an artificial butter flavoring agent in the oil phase. It should be recognized by one skilled in the art, however, that any suitable flavoring agent known in the art may be used.

Typically, when used, the oil phase includes one or more flavoring agents in amounts of from about 0.1% (by weight) to about 0.6% (by weight). In one particular embodiment, the oil phase includes a flavoring agent in an amount of about 0.2% (by weight).

In at least one embodiment, a lower fat content is desirable. Specifically, in recent years, the consumption of reduced and low fat products has increased and intensive research has been made in processing and ingredients in order to achieve better low fat products. In such an embodiment, the oil phase of the spread formulation may further include thickening agents such as a starch and/or a hydrocolloid to be used as fat replacements. One particularly preferred fat replacement is gelatin. Other suitable thickening agents include pectin, carrageenans, agar, Xanthan gum, starch alginates, methocellulose derivatives and combinations thereof.

### Aqueous Phase:

In addition to the oil phase, the oil-in-water spread formulations of the present disclosure include an aqueous phase. Typically, at least about 95% (by weight) of the aqueous phase is water. In addition to the water, the aqueous phase may include one or more of salt or brine, dairy protein, antioxidants, and preservatives.

When used, salts, such as sodium chloride and potassium chloride, are typically included in the aqueous phase in amounts of from about 1.5% (by weight) to about 3.0% (by weight). In one particular embodiment, the aqueous phase includes salt in an amount of about 1.5% (by weight) to behave as both a flavoring agent and a preservative.

Other preservatives that may be included in the aqueous phase include antimicrobial preservatives, antioxidants, and metal scavengers. Common antimicrobial preservatives include benzoic acid, sorbic acid, sodium benzoate and potassium sorbate.

When included, antimicrobial preservatives are typically present in the aqueous phase in amounts of from about 0.1% (by weight) to about 0.2% (by weight)

Exemplary antioxidants that will further improve stability of the fatty acids within the formulations, include ethylenediaminetetraacetic acid (EDTA), tocopherols (Vitamin E), ascorbic acid (Vitamin C), Vitamin C salts (e.g., L-sodium, L-calcium ascorbate), Vitamin C esters (e.g., ascorbyl-5,6-diacetate, ascorbyl-6-palmitate), ethyoxquin, citric acid, calcium citrate, butylated hydroxyl anisole (BHA), butylated hydroxytoluene (BHT), tertiary butyl hydroquinone (TBHQ), natural antioxidants (e.g., rosemary extract), and the like, and combinations thereof. EDTA further acts as an antioxidant synergist, which performs two functions: (1) it increases the antioxidant effectiveness; and (2) it ties up or chelates the trace metals, which are oxidative catalysts. EDTA is also effective as an agent to retard oxidative bleaching of the carotenoid coloring agents used in the oil phase as described above.

Amounts of antioxidants to be added to the formulations will typically depend on the antioxidant to be added, and further, on the other components in the spread formulation. Exemplary amounts of antioxidants to be added include from about 1 ppm to about 200 ppm. More preferably, antioxidants can be added in amounts of from about 10 ppm to about 150 ppm, and even more preferably, from about 10 ppm to about 50 ppm. In one particularly preferred embodiment, the antioxidant is EDTA and the formulation includes about 100 ppm.

Dairy proteins may be included in the aqueous phase to provide improved nutritional value to the spread formulations. Exemplary dairy proteins for use in the aqueous phase may include whole milk, non fat dry milk, sodium caseinates, whey, and combinations thereof.

When used, dairy proteins are included in the aqueous phase in amounts of from about 1% (by weight) to about 10% (by weight). In one particular embodiment, the aqueous phase includes at least one dairy protein in an amount of about 1.2% (by weight).

### Methods of Producing Spread Formulations:

Additionally, the present disclosure is directed to methods of making the spread formulations including SDA. Generally, the spread formulations of the present disclosure are produced by: providing an oil phase comprising a stearidonic acid (SDA)-enriched oil; providing an aqueous phase; and contacting the oil phase and the aqueous phase to make an oil-in-water emulsion spread formulation.

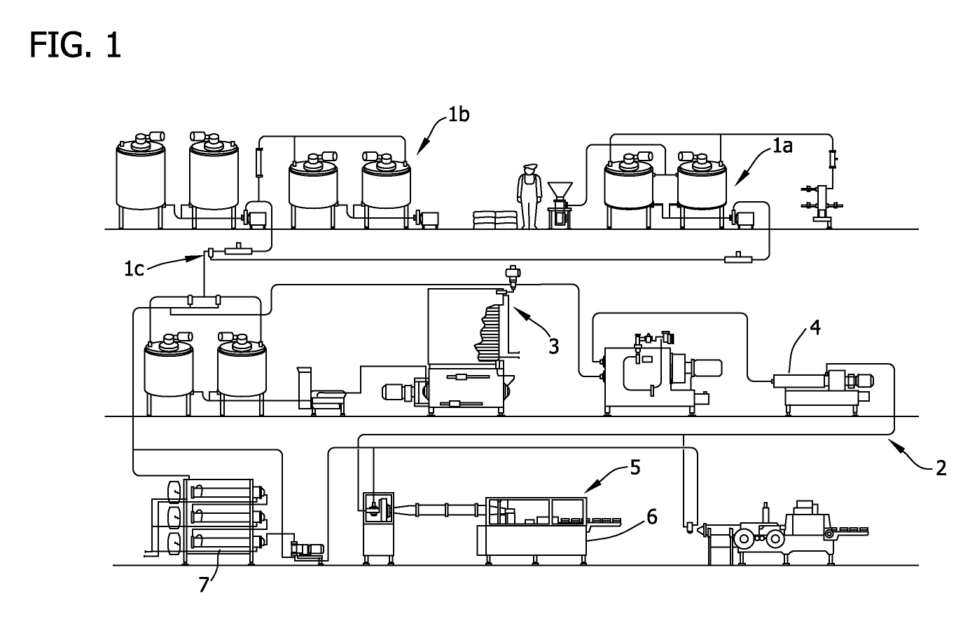

To prepare the oil phase for the spread formulation, the various oils and fats or fat blends may be transferred to an emulsion tank for blending together. Specifically, as shown in FIG. 1 at 1a, the oils and fats are transferred to the tank where the oils and fats are melted and blended. Typically, it is desirable to add the highest melting fats first, followed by the lower melting fats and liquid oils.

Once the oils and fats have been added, emulsifiers and other oil-soluble minor ingredients as described above (e.g., monoglycerides, diglycerides, coloring agents, flavoring agents, etc.) are added to the blend.

Typically, the oils and fats (and any other additional ingredients) are blended at a temperature approximately 5° C. to 8° C. higher than the melting point of the oil phase. More particularly, the oils and fats are blended at a temperature of from about 105° F. (41° C.) to about 110° F. (43° C.).

Once blended together, the oil phase is kept at stable storage temperature above the melting point of the fat and under agitation in order to avoid fractionation of the fat and oils and to allow easy handling.

The aqueous phase is often prepared batch-wise by mixing all ingredients in the aqueous phase in an aqueous phase tank (as shown in FIG. 1 at 1b). The water in the aqueous phase should be of good drinking quality. If drinking quality water cannot be guaranteed, the water can be subjected to pre-treatment by means of e.g., a UV or filter system. In one embodiment, the aqueous phase is mixed and further pasteurized at a temperature of greater than about 150° F. (66° C.) for a time period of about 30 minutes.

The aqueous phase is then added to the oil phase and the oil-in-water emulsion is created under intensive but controlled mixing (see FIG. 1 at 1c). In one embodiment, the emulsion spread formulation is produced and then held at a temperature of from about 105° F. (41° C.) to about 110° F. (43° C.) for a time period of from about 1 hour to about 2 hours. By holding the emulsion spread formulation at these temperatures, the spread formulation is pasteurized. Alternatively, the formulation can be pasteurized using a plate heat exchanger (PHE), as described below.

In another embodiment, as shown in FIG. 1 at 3, the emulsion spread formulation is continuously pumped through either a PHE or a low pressure scraped surface heat exchanger (SSHE), or a high pressure SSHE to be pasteurized. Specifically, the emulsion is heated to a temperature of from about 167° F. (75° C.) to about 176° F. (80° C.) for 15 to 20 seconds and then cooled to a temperature of from about 113° F. (45° C.) to about 122° F. (50° C.) or 5° C. to 8° C. higher than the melting point of the oil phase in the emulsion.

For full fat products, a PHE is typically used for pasteurization. For lower fat versions where the emulsion is expected to exhibit a relatively high viscosity and for heat-sensible emulsions (e.g., emulsions with high protein content) a low pressure SSHE of high pressure SSHE is recommended.

The pasteurization process has several advantages. It ensures inhibition of bacterial growth and growth of other micro-organisms, thus improving the microbiological stability of the emulsion. Pasteurization of the emulsion will minimize the residence time from pasteurized product to filling or packing of the final product.

Furthermore pasteurization of the complete emulsion spread formulation ensures that the emulsion is fed to a crystallization line, described below, at a constant temperature achieving constant processing parameters, product temperatures and product texture. In addition, occurrence of pre-crystallized emulsion fed to the crystallization equipment is prevented when the emulsion is properly pasteurized and fed to the high pressure pump at a temperature approximately 5° C. to 10° C. higher than the melting point of the oil phase.

A typical pasteurization process will, after preparation of the emulsion at a temperature of from about 105° F. (41° C.) to about 110° F. (43° C.), include a heating and holding sequence of the emulsion at from about 167° F. (75° C.) to about 185° F. (85° C.) for 16 seconds and subsequently a cooling process to a temperature of from about 113° F. (45° C.) to about 131° F. (55° C.). The end temperature will depend on the melting point of the oil phase: the higher the melting point, the higher the temperature.

Referring to FIG. 1, the emulsion spread formulation is further pumped to a crystallization line 2, typically by means of a high pressure piston pump (HPP) 101. The crystallization line 2 for the production of spread formulations such as margarine spread formulations typically consists of a high pressure SSHE 4 which is cooled by ammonia or Freon type cooling media (not shown). Pin mixers and/or intermediate crystallizers (not shown) are often included in the line in order to add extra kneading intensity and time for the production of plastic products. A resting tube 7 is the final step of the crystallization line 2 and is only included if the end product is packaged.

The high pressure SSHE 4 super-cools and crystallizes the warm emulsion spread formulation on the inner surface of the chilling tube. The emulsion is efficiently scraped off by the rotating knives, thus the emulsion is chilled and kneaded simultaneously. When the fats in the emulsion crystallize, the fat crystals form a three-dimensional network entrapping droplets of the aqueous phase and the liquid oil of the oil phase, resulting in products with properties of a plastic semi-solid nature.

Depending on the type of spread formulation to be manufactured and the type of fats used for the particular formulation, the configuration of the crystallization line 2 (i.e., the order of the chilling tubes and the pin mixer) can be adjusted to provide the optimum configuration for the particular formulation.

After the formulation is chilled in the SSHE 4, it enters the pin mixer and/or intermediate crystallizers in which it is kneaded for a certain period of time and with a certain intensity in order to assist the promotion of the three-dimensional network, which on the macroscopic level is the plastic structure. If the formulation is meant to be distributed as a wrapped formulation, it will enter the SSHE 4 again before it settles in the resting tube 7 prior to wrapping. If the formulation is filled into cups, no resting tube is included in the crystallization line.

In one embodiment, the warm emulsion spread formulation is pumped into a SSHE to cool the spread formulation to a temperature of from about 34° F. (1° C.) to about 41° F. (5° C.) and then pumped into a pin mixer for kneading.

Various packaging and filling machines are available on the market and will not be described herein. However, the consistency of the formulation is very different if it is produced to be packaged or filled into cups or wrapped. If the formulation is packaged, it must exhibit a firmer texture than a filled formulation, and if this texture is not optimal, the formulation will be diverted to the remelting system (see FIG. 1 at 5), melted and added to the buffer tank 6 for re-processing. Different remelting systems are available, but the most common systems used are PHE or low pressure SSHE.

Surprisingly, the inventors have found that including SDA compositions from transgenic plant sources in spread formulations as described above is highly effective in increasing the omega-3 fatty acid levels of SDA (18:4) and EPA (eicosapentaenoic acid). Furthermore, plant sources, such as soybean oil, have been found to provide more stable fatty acids to the formulations. Specifically, SDA soybean oil was shown to take 5 to 10 times longer to oxidize as measured by peroxide values and anisidine values as compared to fish oils in stability tests.

Furthermore, there has been found to be little difference in the palatability, flavor, texture, or overall consumer acceptability, of the spread formulation including SDA as compared to conventional spread formulations without omega-3 fatty acids. Specifically, as shown in the Example below, SDA-containing spread formulations at 2 weeks had similar flavor, aroma, appearance, mouthfeel, and spreadability as compared to conventional spread formulations without omega-3 fatty acids. At 2 months, the differences perceived between the SDA-containing formulation and the control formulation were in appearance, but, again, no differences in flavor, aroma, mouthfeel, or spreadability. Differences in flavor and aftertaste were not perceived between the SDA-containing formulation and control formulation until 4 months, however aroma, mouthfeel, and spreadability remained similar.

Furthermore, as compared to spread formulations including alternative omega-3 fatty acids, such as spread formulations using fish oils or algal oils, the shelf life of the spread formulation including SDA after nine months was similar to a conventional spread formulation without omega-3 fatty acids. Similar results were obtained for off flavor aftertaste where the spread formulation with SDA was less different from conventional spread formulations as compared to spread formulations using alternate sources of omega-3 fatty acids.

### Illustrative Embodiments of the Disclosure

The following example is included to demonstrate general embodiments of the disclosure. It should be appreciated by those of skill in the art that the techniques disclosed in the example which follows represent techniques discovered by the inventors to function well in the practice of the disclosure, and thus can be considered to constitute preferred modes for its practice. However, those of skill in the art should, in light of the present disclosure, appreciate that many changes can be made in the specific embodiments which are disclosed and still obtain a like or similar result without departing from the disclosure.

All of the compositions and methods disclosed and claimed herein can be made and executed without undue experimentation in light of the present disclosure. While the compositions and methods of this disclosure have been described in terms of preferred embodiments, it will be apparent to those of skill in the art that variations may be applied without departing from the concept and scope of the disclosure.

In the examples below, transgenic soybean oil containing SDA was used. Similar results would be obtained when using oil derived from other transgenic plants such as corn or canola.

### Example 1

### Margarine Spread Formulations—A 9-Month Study

A 9-month study was conducted to determine whether a margarine spread formulation containing SDA had an equivalent sensory shelf life as compared to a control margarine spread formulation (i.e., conventional margarine spread formulations without SDA) and to other spread formulations using alternative omega-3 fatty acids.

The spread formulations analyzed are shown in Table 3.

TABLE 3
Spread Formulations

| | | | | | | |
|---|---|---|---|---|---|---|
| | | | | Spread | | |
| | | Spread | | Formulation | Spread | Spread |
| | | Formulation | WT. % in | with 4.64% | Formulation | Formulation |
| | | with 20% | Phase of | (by weight) | with 3.07% | with 2.65% |
| | Control | (by weight) | Spread | Menhaden | (by weight) | (by weight) |
| | Formulation | SDA | Formulation | Oil | Meg-3 Oil | Algal Oil |
| Ingredient | (wt. %) | (wt. %) | with SDA | (wt. %) | (wt. %) | (wt. %) |

Oil Phase

| | | | | | | |
|---|---|---|---|---|---|---|
| Liquid | 25.0000 | 11.6100 | 19.18165 | 20.3600 | 21.9300 | 23.3500 |
| Soybean | | | | | | |
| Oil (ADM) | | | | | | |
| Margarine | 35.0000 | 35.0000 | 57.82582 | 35.0000 | 35.0000 | 35.0000 |
| Soybean | | | | | | |
| Oil (ADM) | | | | | | |
| SDA- | 0 | 13.3900 | 22.1225 | 0 | 0 | 0 |
| enriched | | | | | | |
| soybean oil | | | | | | |
| (Monsanto) | | | | | | |
| Menhadin- | 0 | 0 | 0 | 4.6400 | 0 | 0 |
| enriched | | | | | | |
| soybean oil | | | | | | |
| (Monsanto) | | | | | | |
| Meg-3- | 0 | 0 | 0 | 0 | 3.0700 | 0 |
| enriched | | | | | | |
| soybean oil | | | | | | |
| (Monsanto) | | | | | | |
| Algal- | 0 | 0 | 0 | 0 | 0 | 2.6500 |
| enriched | | | | | | |
| soybean | | | | | | |
| Oil | | | | | | |
| (Monsanto) | | | | | | |
| Lecithin | 0.2000 | 0.2000 | 0.330433 | 0.2000 | 0.2000 | 0.2000 |
| (Solae Co.) | | | | | | |
| Mono & | 0.2000 | 0.2000 | 0.330433 | 0.2000 | 0.2000 | 0.2000 |
| Di- | | | | | | |
| Glycerides | | | | | | |
| (Danisco) | | | | | | |
| Coloring | 0.0016 | 0.0016 | 0.002643 | 0.0016 | 0.0016 | 0.0016 |
| Agent | | | | | | |
| Flavoring | 0.1250 | 0.1250 | 0.206521 | 0.1250 | 0.1250 | 0.1250 |
| Agent | | | | | | |
| (Givaudan | | | | | | |

Aqueous Phase

| | | | | | | |
|---|---|---|---|---|---|---|
| Water | 37.4634 | 37.4634 | 94.90796 | 37.4634 | 37.4634 | 37.4634 |
| Salt | 1.5000 | 1.5000 | 3.800027 | 1.5000 | 1.5000 | 1.5000 |
| (Morton) | | | | | | |
| Non Fat | 0.5000 | 0.5000 | 1.266676 | 0.5000 | 0.5000 | 0.5000 |
| Dry Milk | | | | | | |
| (Land | | | | | | |
| O'Lakes) | | | | | | |
| EDTA | 0.0100 | 0.0100 | 0.025334 | 0.0100 | 0.0100 | 0.0100 |
| (Brenntag | | | | | | |
| North | | | | | | |
| America) | | | | | | |
| Total | 100.0000 | 100.0000 | | 100.0000 | 100.0000 | 100.0000 |

The spread formulation samples were stored at a temperature of from about 38° F. (3.33° C.) to about 42° F. (5.56° C.) throughout the duration of the study. Two-ounce samples were then submitted for sensory analysis.

A panel of trained assessors (9) participated in discussion and training sessions to identify and define key descriptive attributes that discriminated well between the formulations. In subsequent rating sessions the panel used Quantitative Descriptive Analysis (Tragon Corp., Redwood Shores, Calif.), with verbal anchors to rate the perceived intensity of each attribute. Each panelist assessed one replicate of each sample at five time points (e.g., 2 weeks, 2 mos., 4 mos., 6 mos., and 9 mos.) over a period of nine months. Plain crackers and mineral water were used as palate cleansers between samples. Samples were tasted and chewed, and then spat out rather than being swallowed. The aftertaste of samples was determined five seconds after the samples had been removed from the mouth.

The sensory attributes and definitions produced for the formulations were:

Appearance
Color The intensity of color from pale yellow to darker yellow (light-dark). (evaluated without stirring)

Press sample down with spoon a couple of times and evaluate:
Firm The degree to which sample feels firm and dense (soft-dense).
Glossy The degree to which the sample appears glossy, shiny or has a sheen after being mashed with a spoon (slight-very).
Smooth The degree to which the samples appears smooth, not grainy (grainy-smooth).
Whipped The degree to which sample appears whipped with air, fluffy, not dense, not heavy (slight-very).

Aroma (Lift Lid and Evaluate Immediately)
Overall Intensity The intensity of overall aroma, regardless of type (weak-strong).
Artificial Butter The intensity of artificial butter aroma as in theater popcorn, microwave popcorn imitation butter (weak-strong).
Oily The amount of oily aroma like vegetable oil, greasy or lardy (weak-strong).
Milk Dairy Sweet The intensity of milky, dairy, sweet dairy aroma like the sweet aroma found in butter or dairy cream (weak-strong).
Chemical The intensity of chemical aroma (weak-strong).
Dairy Sour The intensity of dairy sour aroma like sour cream, yogurt, buttermilk (weak-strong).
Fruity (Artificial) The intensity of fruity aroma like an artificial pineapple (weak-strong).
Sweet (Artificial) The intensity of sweet aroma like artificial vanilla (weak-strong).

Mouthfeel
Melt Rate The rate at which formulation melts in your mouth or dissolves (slow-fast).
Inconsistent The degree to which formulation feels lumpy like it contains
Texture teeny tiny bumps or lumps that go away right away (butterlumps) (slight-very).
Greasy/Oily The degree to which formulation feels greasy or oily (watery-greasy).

Flavor
Fruity (Artificial) The intensity of fruity flavor like an artificial pineapple flavor (weak-strong).
Salty The intensity of salty flavor (weak-strong).
Oily The amount of oil flavor like vegetable oil (weak-strong).
Artificial Butter The intensity of artificial butter flavor as in theater popcorn, microwave popcorn imitation butter (weak-strong).
Dairy Sour The intensity of dairy sour flavor, like buttermilk, sour cream, or yogurt (weak-strong).
Real Butter The intensity of butter flavor like that of real butter (weak-strong).
Milky Dairy Sweet The intensity of milky, dairy, sweet dairy flavor like the sweet flavor found in butter or dairy cream (weak-strong).
Chemical The intensity of chemical flavor, not natural (weak-strong).
Bitter The intensity of bitter flavor (weak-strong).
Old The intensity of old flavor, not fresh, has been in refrigerator too long (weak-strong).
Off Flavor The flavor typically not found in spread formulations that provides a negative sensory perception.

Aftertaste (5 Seconds after Removing Formulation from Mouth)
Salty The amount of salty flavor remaining (weak-strong).
Dairy Sour The amount of dairy sour flavor remaining, like buttermilk, yogurt, or sour cream (weak-strong).
Milky Dairy Sweet The amount of milky, dairy, or sweet dairy flavor remaining, like the sweet flavor found in butter or dairy cream (weak-strong).
Real Butter The amount of butter flavor remaining, like that of real butter (weak-strong).
Oily Aftertaste The amount of oil flavor remaining, like vegetable oil, greasy or lardy taste (weak-strong).
Old The amount of old flavor remaining (weak-strong).
Bitter The amount of bitter flavor remaining (weak-strong).

Afterfeel
Astringent The degree to which the formulation leaves your tongue feeling
Mouthfeel astringent, drying, dries the tongue as from too much salt on your tongue (slight-very).
Oily Mouthfeel The degree to which the formulation leaves an oily, greasy coating remaining in the mouth and lips (slight-very).

Spreading onto Bread (Spread with Serrated Side of a Knife 7 Times in all Different Directions)
Spreadable The degree to which formulation appears spreadable and spreads easily from doesn't spread, to hard to spread, to spreads easily (slight-very).
Rips Bread The degree to which the formulation rips or tears the bread while spreading, puts holds in the bread (slight-very).

Appearance on Bread
Shiny The degree to which the formulation appears shiny from a dull matte appearance with no shine to high gloss (slight-very).
Color on Bread The degree of color from pale to dark yellow (light-dark).

The results of the sensory analysis are summarized in Tables 4-8. Differences that were perceived in the SDA-containing formulation as compared to the control formulation at 2 weeks were associated with the salty aftertaste and appearance on bread of the formulation, but not its flavor, aroma, appearance, mouthfeel, or spreadability. At 2 months, the differences perceived between the SDA-containing formulation and the control formulation were in appearance, but, again, no differences in flavor, aroma, mouthfeel, or spreadability. Differences in flavor and aftertaste were not perceived between the SDA-containing formulation and control formulation until 4 months, however aroma, mouthfeel, and spreadability remained similar. At both 6 and 9 months, the SDA-containing formulation was perceived to have a difference in flavor and appearance on bread.

TABLE 4
Effect of omega-3 enriched oil (spread formulation with omega-3 fatty
acids) and conventional soybean oil (control spread formulation) on the sensory
attributes of margarine spread formulations at 2 weeks.

| | Spread Formulation | | | | |
|---|---|---|---|---|---|
| | | | Spread | | |
| | | | Formulation | Spread | Spread |
| | | Spread | with | Formulation | Formulation |
| | Control Spread | Formulation | Menhadin | with Meg-3 | with Algal |
| Attributes | Formulation | with SDA | Oil | Oil | Oil |

Appearance Attributes

| | | | | | |
|---|---|---|---|---|---|
| Color | 12.042abc | 13.25ab | 10.88d | 12.74abc | 11.55cd |
| Firm | 26.02a | 25.92a | 21.57c | 23.71abc | 24.83abc |
| Glossy | 33.38abc | 30.33cd | 32.18bc | 28.48de | 33.73abc |
| Smooth | 45.41ab | 43.55b | 44.57ab | 44.72ab | 45.65ab |
| Whipped | 25.76 | 25.75 | 29.19 | 27.57 | 28.62 |

Aroma Attributes

| | | | | | |
|---|---|---|---|---|---|
| Overall | 15.12 | 14.63 | 15.88 | 15.30 | 16.44 |
| Intensity | | | | | |
| Artificial | 8.52 | 8.30 | 8.22 | 8.63 | 8.45 |
| Butter | | | | | |
| Oily | 9.68 | 9.84 | 8.72 | 8.90 | 10.01 |
| Milk Dairy | 6.88 | 7.32 | 6.53 | 6.68 | 7.93 |
| Sweet | | | | | |
| Chemical | 3.78 | 4.04 | 3.33 | 3.85 | 4.12 |
| Dairy Sour | 4.79b | 5.40b | 5.54ab | 5.10b | 6.35a |
| Fruity | 6.31 | 6.09 | 6.92 | 6.16 | 7.11 |
| (Artificial) | | | | | |
| Sweet | 4.78abc | 4.48bc | 4.58bc | 3.96c | 4.68abc |
| (Artificial) | | | | | |

Mouthfeel Attributes

| | | | | | |
|---|---|---|---|---|---|
| Melt Rate | 34.26b | 35.82ab | 36.13ab | 36.48ab | 34.34b |
| Inconsistent | 2.36 | 2.20 | 2.22 | 2.04 | 2.06 |
| Texture | | | | | |
| Greasy/Oily | 19.32 | 18.85 | 18.52 | 18.49 | 19.26 |

Flavor Attributes

| | | | | | |
|---|---|---|---|---|---|
| Fruity | 11.51 | 12.95 | 11.96 | 12.55 | 12.54 |
| (Artificial) | | | | | |
| Salty | 22.23 | 24.78 | 24.28 | 25.05 | 23.71 |
| Oily | 15.29bc | 15.60abc | 17.38a | 14.93c | 17.32ab |
| Artificial | 13.82 | 14.70 | 14.52 | 15.24 | 14.34 |
| Butter | | | | | |
| Dairy Sour | 8.06 | 7.98 | 8.98 | 8.46 | 8.38 |
| Real Butter | 7.18 | 6.68 | 5.98 | 7.34 | 6.44 |
| Milky | 11.65 | 10.52 | 9.91 | 11.62 | 10.86 |
| Dairy | | | | | |
| Sweet | | | | | |
| Chemical | 5.32b | 5.08b | 8.18a | 5.22b | 7.13a |
| Bitter | 3.16c | 3.81bc | 4.69a | 3.63bc | 4.13ab |
| Old | 1.78 | 1.72 | 2.08 | 1.71 | 1.95 |

Aftertaste Attributes

| | | | | | |
|---|---|---|---|---|---|
| Salty | 17.98b | 21.07a | 19.66ab | 19.60ab | 19.57ab |
| Dairy Sour | 7.50 | 7.95 | 8.45 | 7.96 | 8.07 |
| Milky | 10.42a | 9.74ab | 8.65b | 10.44a | 9.48ab |
| Dairy | | | | | |
| Sweet | | | | | |
| Real Butter | 7.36a | 6.85abc | 6.08c | 7.28ab | 6.25bc |
| Oily | 12.78abcd | 13.68abc | 14.10ab | 11.20d | 14.53a |
| Aftertaste | | | | | |
| Old | 1.84 | 2.02 | 2.23 | 2.02 | 2.01 |
| Bitter | 3.51 | 3.57 | 4.05 | 3.49 | 3.88 |

Afterfeel Attributes

| | | | | | |
|---|---|---|---|---|---|
| Astringent | 13.95 | 14.71 | 15.53 | 15.62 | 15.12 |
| Oily | 13.47 | 13.12 | 13.07 | 12.35 | 13.19 |
| Mouthfeel | | | | | |

Spreading onto Bread Attributes

| | | | | | |
|---|---|---|---|---|---|
| Spreadable | 51.98 | 51.62 | 51.60 | 51.05 | 51.75 |

Appearance on Bread Attributes

| | | | | | |
|---|---|---|---|---|---|
| Shiny | 40.88a | 38.22bc | 42.08a | 40.52ab | 40.36ab |
| Color on | 13.98bcd | 15.16ab | 12.47e | 13.70cde | 13.42cde |
| Bread | | | | | |

TABLE 5
Effect of omega-3 enriched oil (spread formulation with omega-3 fatty
acids) and conventional soybean oil (control spread formulation) on the sensory
attributes of margarine spread formulations at 2 months.

| | Spread Formulation | | | | |
|---|---|---|---|---|---|
| | | | Spread | | |
| | | | Formulation | Spread | Spread |
| | | Spread | with | Formulation | Formulation |
| | Control Spread | Formulation | Menhadin | with Meg-3 | with Algal |
| Attributes | Formulation | with SDA | Oil | Oil | Oil |

Appearance Attributes

| | | | | | |
|---|---|---|---|---|---|
| Color | 11.02bc | 12.28a | 10.53bc | 11.49ab | 10.34c |
| Firm | 22.61ab | 24.81a | 19.39b | 22.99ab | 24.77a |
| Glossy | 28.56a | 24.17c | 28.01ab | 24.86bc | 27.23abc |
| Smooth | 44.81 | 44.59 | 44.40 | 43.25 | 43.07 |
| Whipped | 24.19 | 23.35 | 24.01 | 24.28 | 22.15 |

Aroma Attributes

| | | | | | |
|---|---|---|---|---|---|
| Overall | 15.54abc | 14.08bc | 15.65abc | 16.07abc | 15.06bc |
| Intensity | | | | | |
| Artificial | 10.30 | 10.01 | 10.61 | 11.27 | 10.63 |
| Butter | | | | | |
| Oily | 7.78 | 6.77 | 7.01 | 7.40 | 7.21 |
| Milk Dairy | 7.57 | 6.51 | 7.21 | 6.60 | 6.54 |
| Sweet | | | | | |
| Chemical | 3.96 | 3.91 | 4.06 | 4.59 | 3.96 |
| Dairy Sour | 4.69 | 4.75 | 5.40 | 4.29 | 4.97 |
| Fruity | 8.18 | 7.87 | 8.41 | 8.26 | 7.98 |
| (Artificial) | | | | | |
| Sweet | 5.24 | 4.99 | 5.57 | 5.29 | 4.92 |
| (Artificial) | | | | | |

Mouthfeel Attributes

| | | | | | |
|---|---|---|---|---|---|
| Melt Rate | 35.95 | 36.66 | 37.35 | 36.91 | 36.93 |
| Inconsistent | 2.81 | 1.96 | 1.81 | 1.76 | 2.15 |
| Texture | | | | | |
| Greasy/Oily | 15.66 | 16.39 | 16.62 | 16.77 | 17.04 |

Flavor Attributes

| | | | | | |
|---|---|---|---|---|---|
| Fruity | 13.10 | 11.30 | 12.50 | 12.50 | 10.89 |
| (Artificial) | | | | | |
| Salty | 20.69 | 21.17 | 21.02 | 21.11 | 20.22 |
| Oily | 13.14 | 14.02 | 13.71 | 13.99 | 14.61 |
| Artificial | 7.14 | 6.72 | 15.19 | 15.34 | 16.02 |
| Butter | | | | | |
| Dairy Sour | 7.49 | 7.66 | 8.44 | 8.04 | 7.46 |
| Real Butter | 7.14ab | 6.72abc | 6.86abc | 7.51a | 6.01bc |
| Milky | 10.54a | 9.52abc | 10.09ab | 10.22ab | 8.69bcd |
| Dairy | | | | | |
| Sweet | | | | | |
| Chemical | 4.16d | 5.12abcd | 5.33abcd | 4.69bcd | 4.91bcd |
| Bitter | 2.89b | 3.29ab | 3.69ab | 3.66ab | 3.71ab |
| Old | 2.17 | 2.76 | 2.97 | 2.56 | 2.59 |
| Off Flavor | 6.10d | 6.69cd | 8.13bcd | 7.65bcd | 10.14abc |

Aftertaste Attributes

| | | | | | |
|---|---|---|---|---|---|
| Salty | 17.24 | 17.16 | 18.94 | 17.92 | 16.93 |
| Dairy Sour | 7.03 | 7.05 | 7.20 | 7.40 | 6.85 |
| Milky | 8.86ab | 8.72abc | 8.16abc | 9.14a | 7.81bc |
| Dairy | | | | | |
| Sweet | | | | | |
| Real Butter | 7.19a | 6.85ab | 5.85abc | 7.04ab | 5.87abc |
| Oily | 10.44ab | 11.51ab | 11.70a | 12.06a | 11.94a |
| Aftertaste | | | | | |
| Old | 2.34 | 2.72 | 2.45 | 3.00 | 2.83 |
| Off Flavor | 5.91cd | 5.41cd | 6.31cd | 6.74bcd | 8.89abc |
| Bitter | 2.84bc | 2.89bc | 3.56ab | 3.46abc | 3.56ab |

Afterfeel Attributes

| | | | | | |
|---|---|---|---|---|---|
| Astringent | 11.87 | 12.15 | 12.91 | 12.96 | 13.76 |
| Oily | 10.36 | 10.76 | 10.25 | 10.54 | 9.83 |
| Mouthfeel | | | | | |

Spreading onto Bread Attributes

| | | | | | |
|---|---|---|---|---|---|
| Spreadable | 50.31 | 50.11 | 49.64 | 50.31 | 50.03 |

Appearance on Bread Attributes

| | | | | | |
|---|---|---|---|---|---|
| Shiny | 41.77ab | 38.43cd | 43.24a | 40.17bc | 42.01ab |
| Color on | 12.97bc | 14.19ab | 12.81c | 14.44a | 12.57c |
| Bread | | | | | |

TABLE 6
Effect of omega-3 enriched oil (spread formulation with omega-3 fatty
acids) and conventional soybean oil (control spread formulation) on the sensory
attributes of margarine spread formulations at 4 months.

| | Spread Formulation | | | | |
|---|---|---|---|---|---|
| | | | Spread | | |
| | | | Formulation | Spread | Spread |
| | | Spread | with | Formulation | Formulation |
| | Control Spread | Formulation | Menhadin | with Meg-3 | with Algal |
| Attributes | Formulation | with SDA | Oil | Oil | Oil |

Appearance Attributes

| | | | | | |
|---|---|---|---|---|---|
| Color | 12.24ab | 12.10abc | 10.12ef | 11.51bcd | 10.91cde |
| Firm | 28.67 | 28.19 | 22.97 | 26.96 | 26.17 |
| Glossy | 26.76ab | 21.77bcd | 26.33ab | 25.92abc | 26.59ab |
| Smooth | 46.18a | 44.83ab | 44.96ab | 44.46ab | 44.87ab |
| Whipped | 28.16 | 26.81 | 28.77 | 27.46 | 28.11 |

Aroma Attributes

| | | | | | |
|---|---|---|---|---|---|
| Overall | 17.83 | 16.68 | 17.65 | 16.09 | 17.81 |
| Intensity | | | | | |
| Artificial | 10.32 | 10.25 | 9.52 | 8.73 | 9.77 |
| Butter | | | | | |
| Oily | 10.22 | 9.70 | 9.82 | 9.19 | 9.69 |
| Milk Dairy | 6.52 | 7.08 | 6.79 | 6.89 | 6.78 |
| Sweet | | | | | |
| Chemical | 3.58ab | 3.81ab | 4.11ab | 3.17b | 4.02ab |
| Dairy Sour | 4.57 | 5.45 | 4.82 | 4.31 | 4.68 |
| Fruity | 7.77 | 9.24 | 8.97 | 7.71 | 8.25 |
| (Artificial) | | | | | |
| Sweet | 5.82ab | 7.43a | 5.47b | 6.21ab | 5.84ab |
| (Artificial) | | | | | |

Mouthfeel Attributes

| | | | | | |
|---|---|---|---|---|---|
| Melt Rate | 36.99 | 35.99 | 36.42 | 39.72 | 38.22 |
| Inconsistent | 4.81 | 5.15 | 4.12 | 4.51 | 4.66 |
| Texture | | | | | |
| Greasy/Oily | 21.74 | 22.16 | 22.37 | 23.52 | 22.48 |

Flavor Attributes

| | | | | | |
|---|---|---|---|---|---|
| Fruity | 16.36 | 15.77 | 16.07 | 14.84 | 15.08 |
| (Artificial) | | | | | |
| Salty | 25.48abcd | 25.90abcde | 26.00abc | 23.33d | 25.84abc |
| Oily | 17.65de | 19.22abcde | 18.02cde | 19.77abc | 18.52bcde |
| Artificial | 16.53a | 15.88a | 14.68ab | 13.22b | 15.03ab |
| Butter | | | | | |
| Dairy Sour | 9.19 | 8.83 | 8.80 | 8.12 | 8.08 |
| Real Butter | 7.32a | 6.00bcd | 6.37abc | 5.45cd | 5.51cd |
| Milky | 10.65a | 9.28abc | 9.33abc | 8.15c | 8.49c |
| Dairy | | | | | |
| Sweet | | | | | |
| Chemical | 4.53c | 5.70bc | 6.10bc | 6.59ab | 6.11bc |
| Bitter | 2.51b | 3.85a | 3.74a | 3.92a | 3.83a |
| Old | 1.93b | 2.00b | 2.73ab | 2.58ab | 2.33b |
| Off Flavor | 4.74c | 8.11abc | 8.00abc | 9.65ab | 10.92a |

Aftertaste Attributes

| | | | | | |
|---|---|---|---|---|---|
| Salty | 20.43 | 21.76 | 21.09 | 21.12 | 21.73 |
| Dairy Sour | 8.24ab | 7.59ab | 7.79ab | 8.48ab | 7.11b |
| Milky | 9.62a | 8.98abc | 8.78abcd | 8.28abcd | 7.84bcd |
| Dairy | | | | | |
| Sweet | | | | | |
| Real Butter | 7.38a | 5.62cd | 6.29bc | 5.49cd | 5.80bcd |
| Oily | 14.27b | 16.58a | 15.90ab | 16.32a | 16.03ab |
| Aftertaste | | | | | |
| Old | 2.25 | 2.12 | 2.54 | 2.62 | 2.32 |
| Off Flavor | 4.49b | 6.57ab | 6.98ab | 8.45ab | 9.76a |
| Bitter | 2.95 | 3.49 | 2.99 | 3.37 | 3.48 |

Afterfeel Attributes

| | | | | | |
|---|---|---|---|---|---|
| Astringent | 13.77bc | 15.98ab | 14.49abc | 13.81bc | 12.28c |
| Oily | 11.88 | 13.38 | 14.28 | 13.52 | 13.05 |
| Mouthfeel | | | | | |

Spreading onto Bread Attributes

| | | | | | |
|---|---|---|---|---|---|
| Spreadable | 50.78 | 51.36 | 51.39 | 51.41 | 51.19 |

Appearance on Bread Attributes

| | | | | | |
|---|---|---|---|---|---|
| Shiny | 40.67ab | 37.42bc | 40.76ab | 39.38abc | 40.32abc |
| Color on | 12.39abc | 12.83ab | 11.22cd | 12.06bcd | 11.12cd |
| Bread | | | | | |

TABLE 7
Effect of omega-3 enriched oil (spread formulation with omega-3 fatty
acids) and conventional soybean oil (control spread formulation) on the sensory
attributes of margarine spread formulations at 6 months.

| | Spread Formulation | | | | |
|---|---|---|---|---|---|
| | | | Spread | | |
| | | | Formulation | Spread | Spread |
| | | Spread | with | Formulation | Formulation |
| | Control Spread | Formulation | Menhadin | with Meg-3 | with Algal |
| Attributes | Formulation | with SDA | Oil | Oil | Oil |

Appearance Attributes

| | | | | | |
|---|---|---|---|---|---|
| Color | 12.84abc | 13.59a | 12.12bcd | 12.95abc | 12.62abcd |
| Firm | 24.26 | 25.47 | 23.26 | 23.04 | 24.45 |
| Glossy | 23.80cd | 22.53cde | 25.58bc | 21.55de | 25.57bc |
| Smooth | 43.78bcd | 44.97abc | 44.12abcd | 45.60ab | 43.92bcd |
| Whipped | 24.85 | 23.65 | 26.74 | 26.23 | 25.42 |

Aroma Attributes

| | | | | | |
|---|---|---|---|---|---|
| Overall | 14.22b | 15.28ab | 16.28ab | 16.06ab | 16.90a |
| Intensity | | | | | |
| Artificial | 8.45 | 8.83 | 9.52 | 10.01 | 9.41 |
| Butter | | | | | |
| Oily | 9.07ab | 9.93ab | 9.93ab | 9.84ab | 9.92ab |
| Milk Dairy | 8.93 | 8.50 | 8.16 | 6.99 | 7.72 |
| Sweet | | | | | |
| Chemical | 3.62c | 4.08bc | 4.65abc | 4.63abc | 4.94ab |
| Dairy Sour | 5.14 | 5.36 | 5.90 | 5.88 | 5.65 |
| Fruity | 5.99 | 6.75 | 6.98 | 7.03 | 6.79 |
| (Artificial) | | | | | |
| Sweet | 4.90 | 5.60 | 5.47 | 5.34 | 5.27 |
| (Artificial) | | | | | |

Mouthfeel Attributes

| | | | | | |
|---|---|---|---|---|---|
| Melt Rate | 41.43 | 42.00 | 42.17 | 42.38 | 41.74 |
| Inconsistent | 2.33 | 2.94 | 2.14 | 2.28 | 2.27 |
| Texture | | | | | |
| Greasy/Oily | 17.85 | 17.64 | 18.22 | 18.32 | 18.97 |

Flavor Attributes

| | | | | | |
|---|---|---|---|---|---|
| Fruity | 1.42ab | 12.53ab | 13.31a | 10.96cd | 10.19d |
| (Artificial) | | | | | |
| Salty | 25.63 | 25.59 | 25.32 | 24.89 | 24.77 |
| Oily | 14.59c | 16.63b | 16.89b | 17.49ab | 18.69a |
| Artificial | 13.47 | 13.67 | 13.95 | 14.09 | 13.00 |
| Butter | | | | | |
| Dairy Sour | 10.52 | 10.11 | 11.29 | 10.83 | 10.64 |
| Real Butter | 8.19a | 6.23b | 6.02b | 5.01b | 4.97b |
| Milky | 11.67ab | 10.38bcd | 10.59bc | 8.82de | 8.12e |
| Dairy | | | | | |
| Sweet | | | | | |
| Chemical | 5.61d | 6.90c | 6.77c | 7.64abc | 8.22ab |
| Bitter | 4.43de | 5.27cd | 5.07cde | 6.37ab | 6.67a |
| Old | 2.15 | 2.81 | 2.45 | 2.85 | 2.98 |
| Off Flavor | 7.69d | 13.76c | 13.27c | 17.88a | 18.94a |

Aftertaste Attributes

| | | | | | |
|---|---|---|---|---|---|
| Salty | 20.88 | 21.37 | 20.59 | 21.40 | 21.32 |
| Dairy Sour | 9.13 | 10.30 | 10.34 | 10.35 | 10.68 |
| Milky | 11.11ab | 10.29bc | 10.41abc | 9.86cd | 8.68d |
| Dairy | | | | | |
| Sweet | | | | | |
| Real Butter | 8.07a | 6.89bc | 6.89bc | 5.86cd | 5.42d |
| Oily | 11.02c | 11.43bc | 12.65ab | 13.12a | 13.57a |
| Aftertaste | | | | | |
| Old | 6.65 | 10.23 | 2.38 | 2.68 | 2.71 |
| Off Flavor | 6.65f | 10.23de | 8.91e | 12.62bc | 15.27a |
| Bitter | 4.00cd | 4.88abc | 4.51bc | 5.34ab | 5.89a |

Afterfeel Attributes

| | | | | | |
|---|---|---|---|---|---|
| Astringent | 13.07 | 12.67 | 13.60 | 13.21 | 12.76 |
| Oily | 12.38 | 11.64 | 12.28 | 12.47 | 12.20 |
| Mouthfeel | | | | | |

Spreading onto Bread Attributes

| | | | | | |
|---|---|---|---|---|---|
| Spreadable | 52.69 | 52.22 | 52.91 | 52.74 | 53.00 |

Appearance on Bread Attributes

| | | | | | |
|---|---|---|---|---|---|
| Shiny | 44.73abc | 44.05bc | 46.70a | 44.44bc | 45.98ab |
| Color on | 15.15bcd | 16.29a | 14.09d | 15.32abc | 14.60cd |
| Bread | | | | | |

TABLE 8
Effect of omega-3 enriched oil (spread formulation with omega-3 fatty
acids) and conventional soybean oil (control spread formulation) on the sensory
attributes of margarine spread formulations at 9 months.

| | Spread Formulation | | | | |
|---|---|---|---|---|---|
| | | | Spread | | |
| | | | Formulation | Spread | Spread |
| | | Spread | with | Formulation | Formulation |
| | Control Spread | Formulation | Menhadin | with Meg-3 | with Algal |
| Attributes | Formulation | with SDA | Oil | Oil | Oil |

Appearance Attributes

| | | | | | |
|---|---|---|---|---|---|
| Color | 16.76ab | 17.50ab | 16.01bc | 16.43bc | 14.93c |
| Firm | 24.23 | 24.94 | 23.17 | 25.54 | 25.02 |
| Glossy | 19.09bc | 16.57bc | 18.52bc | 20.27ab | 23.49a |
| Smooth | 40.06abc | 38.64bc | 39.89bc | 40.39abc | 42.71a |
| Whipped | 19.88 | 19.83 | 19.39 | 17.00 | 19.63 |

Aroma Attributes

| | | | | | |
|---|---|---|---|---|---|
| Overall | 14.37 | 13.81 | 15.28 | 13.77 | 16.66 |
| Intensity | | | | | |
| Artificial | 9.64 | 8.74 | 10.66 | 9.89 | 11.10 |
| Butter | | | | | |
| Oily | 8.72 | 8.14 | 8.84 | 8.50 | 9.66 |
| Milk Dairy | 4.48 | 5.04 | 4.69 | 4.53 | 5.47 |
| Sweet | | | | | |
| Chemical | 3.62 | 4.24 | 5.42 | 4.51 | 5.11 |
| Dairy Sour | 4.51 | 4.72 | 4.22 | 4.34 | 5.00 |
| Fruity | 6.13 | 6.49 | 6.21 | 6.60 | 6.77 |
| (Artificial) | | | | | |
| Sweet | 4.21 | 4.91 | 4.57 | 4.73 | 4.54 |
| (Artificial) | | | | | |

Mouthfeel Attributes

| | | | | | |
|---|---|---|---|---|---|
| Melt Rate | 36.13 | 37.72 | 36.82 | 36.07 | 36.16 |
| Inconsistent | 2.16 | 2.73 | 1.87 | 2.37 | 1.56 |
| Texture | | | | | |
| Greasy/Oily | 20.37 | 19.87 | 19.86 | 20.83 | 22.32 |

Flavor Attributes

| | | | | | |
|---|---|---|---|---|---|
| Fruity | 10.94abc | 11.54abc | 9.90c | 10.22bc | 10.31bc |
| (Artificial) | | | | | |
| Salty | 22.48 | 23.19 | 22.57 | 20.46 | 20.59 |
| Oily | 16.33 | 17.50 | 16.89 | 17.89 | 17.08 |
| Artificial | 13.18 | 12.71 | 13.81 | 12.89 | 13.53 |
| Butter | | | | | |
| Dairy Sour | 7.47ab | 6.30ab | 6.66ab | 5.76b | 6.16b |
| Real Butter | 4.49ab | 4.08abc | 3.41bcde | 2.72de | 2.37e |
| Milky | 5.27ab | 4.53abc | 4.32abcd | 3.30d | 3.57cd |
| Dairy | | | | | |
| Sweet | | | | | |
| Chemical | 5.31d | 7.76bcd | 11.50abc | 11.73ab | 11.71ab |
| Bitter | 3.87c | 4.77bc | 6.78ab | 7.10a | 6.90ab |
| Old | 2.03 | 2.96 | 3.66 | 3.43 | 2.72 |
| Off Flavor | 7.14c | 12.23bc | 16.21ab | 18.26a | 19.50a |

Aftertaste Attributes

| | | | | | |
|---|---|---|---|---|---|
| Salty | 20.74 | 20.94 | 19.43 | 19.51 | 19.41 |
| Dairy Sour | 6.36 | 6.38 | 6.77 | 5.59 | 5.93 |
| Milky | 5.37a | 4.22bc | 3.70c | 3.56c | 3.58c |
| Dairy | | | | | |
| Sweet | | | | | |
| Real Butter | 4.23ab | 3.21bc | 3.06c | 2.39c | 2.40c |
| Oily | 13.21 | 13.19 | 13.13 | 12.99 | 14.10 |
| Aftertaste | | | | | |
| Old | 1.81 | 2.00 | 3.10 | 2.99 | 3.08 |
| Off Flavor | 5.34e | 10.10cd | 12.97bc | 15.88ab | 17.66a |
| Bitter | 3.58e | 4.94abcd | 6.01a | 6.06a | 5.68ab |

Afterfeel Attributes

| | | | | | |
|---|---|---|---|---|---|
| Astringent | 12.61 | 12.43 | 12.08 | 12.03 | 11.73 |
| Oily | 13.92 | 13.10 | 13.40 | 13.04 | 13.51 |
| Mouthfeel | | | | | |

Spreading onto Bread Attributes

| | | | | | |
|---|---|---|---|---|---|
| Spreadable | 50.33 | 50.10 | 50.88 | 50.62 | 51.32 |

Appearance on Bread Attributes

| | | | | | |
|---|---|---|---|---|---|
| Shiny | 36.87ab | 33.37bcd | 35.74abc | 35.17abc | 35.82abc |
| Color on | 18371bcd | 19.80abc | 19.49abcd | 20.22ab | 18.08cd |
| Bread | | | | | |

^{a,b}Within a row, values without a common superscript differ significantly (P < 0.05)

### CONCLUSION

Throughout the shelf life, the flavor attributes of the spread formulation with SDA closely resembled the control spread formulation. In comparison to spread formulations made with a competitive set of omega-3 oils including two sources of fish oil and algal oil, off flavor after nine months of shelf life of the spread formulation with SDA was not significantly different from the control spread formulation, wherein the alternate forms of omega-3 oils were all significantly different from the control. Similar results were obtained for off flavor aftertaste where the spread formulation with SDA was less different from the control spread formulation than the alternate sources of omega-3.

### REFERENCES

The references cited in this application, both above and below, are specifically incorporated herein by reference.
1. Harris W S, DiRienzo M A, Sands S A, George C, Jones P G, and Eapen, A K (2007) Stearidonic Acid Increases the Red Blood Cell and Heart Eicosapentaenoic Acid Content in Dogs, Lipids 42:325-33.
2. James, M. J., Ursin V. M., and Cleland L. G. (2003) Metabolism of stearidonic acid in human subjects: comparison with the metabolism of other n-3 fatty acids. AM J CLIN NUTR 2003; 77:1140-5.
3. Miles E A, Banerjee T. and Calder, P. C. (2004), The influence of different combinations of gamma-linolenic acid, stearidonic acid and EPA on immune function in healthy young male subjects. BR J NUTR. 2004 June; 91(6):893-903.
4. O'Brien, Richard D. (2003), Fats and Oils: Formulating and Processing, 2^{nd}. Ed., CRC Press, New York, pp. 383-400.
5. Ursin G. et al., (2003), Modification of plant lipids for human health: Development of functional land-based omega-3 fatty acids. J. NUTR. 133:4271-4274.

1. A spread formulation comprising an oil phase and an aqueous phase, wherein the oil phase comprises stearidonic acid (SDA)-enriched oil.

2. (canceled)

3. The spread formulation of claim 1, wherein the SDA-enriched oil is SDA-enriched soybean oil.

4-6. (canceled)

7. The spread formulation of claim 1, wherein the oil phase further comprises an oil selected from the group consisting of hydrogenated oils, partially hydrogenated oils, interesterified oils, and combinations thereof.

8. (canceled)

9. The spread formulation of claim 7, wherein the oil phase further comprises a liquid oil selected from the group consisting of soybean oil, canola oil, rapeseed oil, palm oil, and combinations thereof.

10. The spread formulation of claim 9, wherein the oil phase further comprises at least one of monoglycerides, diglycerides, and lecithin.

11. (canceled)

12. The spread formulation of claim 1, wherein the oil phase further comprises at least one high stability oil selected from the group consisting of low linolenic soybean oil, high oleic soybean oil, high oleic/low saturate soybean oil, high oleic canola oil, sunflower oil, and combinations thereof.

13-14. (canceled)

15. The spread formulation of claim 1, wherein the aqueous phase further comprises at least one of a salt, a dairy protein, ethylenediaminetetraacetic acid (EDTA), and a preservative.

16-18. (canceled)

19. A margarine spread formulation comprising an oil phase and an aqueous phase, the oil phase comprising stearidonic acid (SDA)-enriched soybean oil.

20-22. (canceled)

23. The margarine spread formulation of claim 19, wherein the oil phase further comprises an oil selected from the group consisting of hydrogenated oils, partially hydrogenated oils, interesterified oils, and combinations thereof.

24-34. (canceled)

35. The margarine spread formulation of claim 19, wherein the aqueous phase further comprises at least one of a salt, a dairy protein, ethylenediaminetetraacetic acid (EDTA), and a preservative.

36-39. (canceled)

40. A method of producing a spread formulation for human consumption comprising:
a. providing an oil phase comprising a stearidonic acid (SDA)-enriched oil;
b. providing an aqueous phase; and
c. contacting the oil phase and the aqueous phase to make an oil-in-water emulsion spread formulation.

41. The method of claim 40, wherein the oil phase is provided by blending the SDA-enriched oil with at least one of a liquid oil, a hydrogenated oil, a partially hydrogenated oil, and an interesterified oil.

42-46. (canceled)

47. The method of claim 41, further comprising blending at least one of monoglycerides, diglycerides, and lecithin into the oil phase.

48. (canceled)

49. The method of claim 47, further comprising blending at least one high stability oil selected from the group consisting of low linolenic soybean oil, high oleic soybean oil, high oleic/low saturate soybean oil, high oleic canola oil, and sunflower oil into the oil phase.

50. (canceled)

51. The method of claim 47, wherein the blending is conducted at a temperature of from about 105° F. (41° C.) to about 110° F. (43° C.).

52. The method of claim 40, wherein the aqueous phase is provided by blending water with at least one of a salt, a dairy protein, and ethylenediaminetetraacetic acid (EDTA).

53-57. (canceled)

58. The method of claim 40 further comprising pasteurizing the aqueous phase at a temperature of greater than about 150° F. (66° C.) for a time period of about 30 minutes.

59. The method of claim 40, wherein the oil phase and aqueous phase are blended together to form the oil-in-water emulsion spread formulation, and wherein the spread formulation is held at a temperature of from about 105° F. (41° C.) to about 110° F. (43° C.) for a time period of from about 1 hour to about 2 hours.

60. The method of claim 59 further comprising pumping the spread formulation into a scraped surface heat exchanger to cool the spread formulation to a temperature of from about 34° F. (1° C.) to about 41° F. (5° C.) and then pumping the cooled spread formulation into a pin mixer.

61. (canceled)

62. The margarine spread formulation of claim 23, wherein the oil phase further comprises at least one of a liquid oil selected from the group consisting of soybean oil, canola oil, rapeseed oil, palm oil, and combinations thereof; monoglycerides; diglycerides; lecithin; and a high stability oil selected from the group consisting of low linolenic soybean oil, high oleic soybean oil, high oleic/low saturate soybean oil, high oleic canola oil, sunflower oil, and combinations thereof.
